(19) United States
(12) Patent Application Publication
(10) Pub. No.: US 2009/0171903 A1
(43) Pub. Date: Jul. 2, 2009

(54) Business Rules Externalization System

(75) Inventors: Peter Lin, Worcester, MA (US); Eric Gelman, Middletown, CT (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Aetna Inc., Hartford, CT (US)

(21) Appl. No.: 11/966,993

(22) Filed: Dec. 29, 2007

(51) Int. Cl. G06F 17/30; G06F 21/00

(52) U.S. Cl. 707/3; 726/1; 707/E17.014

(57) ABSTRACT

A business rules externalization system is provided for centrally storing, compiling, and distributing computer readable business rules employed by a plurality of multi-tiered applications executing the rules in native application code. The system includes a rule database for centrally storing the rules in a standardized format, including multiple versions of a given rule or set of rules. The rule externalization system employs a rule object module to declare and store the rules in a standardized format. When an application encounters a trigger point, it interfaces with a rule object module to request the desired rules. The rule object module queries the rule database for the appropriate version of the requested rules and passes the standardized rules to a compiler module. The rule compiler module translates each rule into application-specific computer executable code or format and returns native code-based rules to the rule object module for transmission to the calling application.

### FIELD OF THE INVENTION

This invention relates generally to the field of enterprise management and more specifically to the area of externalization and delivery of computer readable business rules.

### BACKGROUND OF THE INVENTION

Enterprise systems frequently rely on evaluating a variety of business rules as part of their day-to-day operation. Business rules typically associate conditional tests with operational decisions or actions to be carried out by a plurality of enterprise applications. For instance, in a health care enterprise setting, an application may need to determine whether a user's health plan includes a vision discount benefit in order to display a link to participating vision care providers via an online user interface. Some enterprise applications engage in processing of the business rules that are hard-coded in the application code, while other applications rely on a stand-alone rules engine to perform an evaluation based on its own set of hard-coded rules and return the evaluation result.

Since enterprise systems include many applications running at different system layers or tiers, hard-coded business rules reside in a multi-tiered application environment. A user interface tier application, for example, relies on its own set of hard-coded business rules to perform user authentication, while a middle tier application server employs another set of hard-coded rules for the same task. Multi-tiered nature of distributed business rules impedes efficient rule administration and maintenance across the enterprise and may result in conflicting rules across the application layers due to difficulty in tracking different versions of the same rule. Furthermore, business rules maintained via a rules engine application are coded in a proprietary format that is not compatible across all applications. Likewise, business rules hard-coded in various enterprise applications are not amenable to central administration due to incompatible application formats.

### BRIEF SUMMARY OF THE INVENTION

Embodiments of the invention are used to provide a business rules externalization system and method for centrally storing, compiling, and distributing computer readable business rules employed by a plurality of multi-tiered applications capable of executing the rules in native application code. The rule externalization system includes a rule database for centrally storing a plurality of rules in a standardized format. The rule database includes multiple versions of a given rule or set of rules used by a plurality of applications, or by a single application in response to different triggering events. Preferably, the rule externalization system employs a rule object module to declare and store the rules in a format conforming to a Rule Markup Language (RuleML) standard. The rules comprise logical statements to provide inferential processing based on specified conditions, such as through forward chaining (data driven) or backward chaining (goal driven) evaluation.

To load balance the processing of the rules, the rule externalization system distributes the rules among a plurality of application tiers to one or more applications for evaluation in native application code. For example, in one embodiment, a thick client application implements a question and answer user interface employed by a clinician during a disease management call with a patient for asking the patient a series of dynamically generated health questions to assess the patient's health status. The thick client evaluates patient answers in accordance with one or more rules coded in JavaScript or Java in order to dynamically generate subsequent questions (e.g., if patient is taking blood pressure medication, prompt for a most recent blood pressure reading). In another embodiment, a web-based thick client application encounters a rule trigger requiring it to obtain one or more rules in native format to locally validate user input of form data or to provide user authentication.

Similarly, a middle tier application evaluates one or more rules in its native application code, for example in Java, to provide backend processing of data, such as message routing between applications, or any other type of rules-based processing capable of being performed on an application server. When the rules pertain to persistence, selection and manipulation of data, a database application evaluates the rules coded in Standard Query Language (SQL), such as to provide condition-based data storage or to facilitate condition-based data distribution and display. A rule editor application, in turn, creates and edits the rules. In one embodiment, the rule editor is a Microsoft Excel™ application compatible with Binary Interchange File Format (BIFF) and Open Office XML file formats. Other embodiments include using a third-party dedicated rule editor application for creating and editing the business rules in native syntax. In an embodiment, at least some applications (e.g., a thin client) require an input of a rule evaluation result from a rules engine application. In this case, a dedicated rules engine application processes the rules in accordance with its native application code or format, such as Structured Rule Language (SRL).

At predetermined points during application execution (trigger points), an application requires an input comprising one or more native format rules for local evaluation. Therefore, when the application encounters a trigger point, it interfaces with a rule object module to request the desired rules by passing a list of parameters comprising a name, id, and version number of the desired rule or rule set. The rule object module, in turn, queries the rule database for the appropriate version of the requested rules and passes the standardized rules to a compiler module for customization. The rule compiler module translates each rule or rule set into application-specific computer executable code or format native to the calling application and returns one or more native code-based rules to the rule object module for transmission to the calling application.

Preferably, the rule object module implements a rule object model for declaring, maintaining, and communicating the rules. The rule object model comprises a rule service object, a rule object, a rule data access object (rule DAO), and a rule analysis object. The rule service object receives a set of parameters comprising a rule request (e.g., a rule or rule set name, id, and version number) from one or more calling applications and queries the rule database for the standardized version of one or more rules. The rules are instantiated via a rule object. The rule compiler receives one or more rule objects and compiles the standardized rules into computer executable code native to the calling application. In one embodiment, the rule compiler accesses a registry or a lookup table for matching incoming rule requests with native application code specific to a given calling application. Alternatively, the rule compiler identifies native application code based on rule request parameters passed by the application. Upon generating native application code to customize the rule, the rule compiler passes the customized rule to the calling/requesting application for evaluation.

In one aspect of the invention, a computer system is provided for externalizing a plurality of computer readable business rules, the system comprising a rule repository for centrally storing the plurality of computer readable business rules in a standardized format, a rule object module for querying the rule repository for at least one business rule in response to receiving a rule request from an application, and a rule compiler module for receiving the at least one business rule from the rule object module and compiling the at least one business rule from the standardized format to a computer readable native application format, the rule object module forwarding at least one compiled business rule from the rule compiler module to the application for evaluating the at least one compiled business rule in the computer readable native application format to perform an action.

In another aspect of the invention, a computer readable medium is provided having stored thereon computer executable instructions for externalizing a plurality of computer readable business rules, the instructions comprising centrally storing the plurality of computer readable business rules in a standardized format, initiating a query for at least one business rule in response to receiving a rule request from an application, locating the at least one business rule and compiling the at least one business rule from the standardized format to a computer readable native application format, and forwarding at least one compiled business rule to the application for evaluating the at least one compiled business rule in the computer readable native application format to perform an action.

In yet another aspect of the invention, a method is provided for externalizing a plurality of computer readable business rules, the method comprising centrally storing the plurality of computer readable business rules in a standardized format, initiating a query for at least one business rule in response to receiving a rule request from an application, locating the at least one business rule and compiling the at least one business rule from the standardized format to a computer readable native application format, and forwarding at least one compiled business rule to the application for evaluating the at least one compiled business rule in the computer readable native application format to perform an action.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a diagram illustrating an implementation of a system representing an enterprise application environment, including a business rules externalization system for centrally storing, compiling, and distributing computer readable business rules employed by a plurality of applications capable of executing the rules in native application code, as contemplated by an embodiment of the present invention;

FIG. 2 is a diagram illustrating the business rule externalization system of FIG. 1 in more detail, as contemplated by an embodiment of the present invention;

FIGS. 3-6 are class diagrams respectively illustrating the rule service object, rule object, rule data access object, and rule analysis object of an extensible rule object model of FIG. 2, in accordance with an embodiment of the invention; and

FIG. 7 is a flow chart illustrating a method for externalizing a plurality of computer readable business rules, in accordance with an embodiment of the invention.

### DETAILED DESCRIPTION OF THE INVENTION

The following examples further illustrate the invention but, of course, should not be construed as in any way limiting its scope.

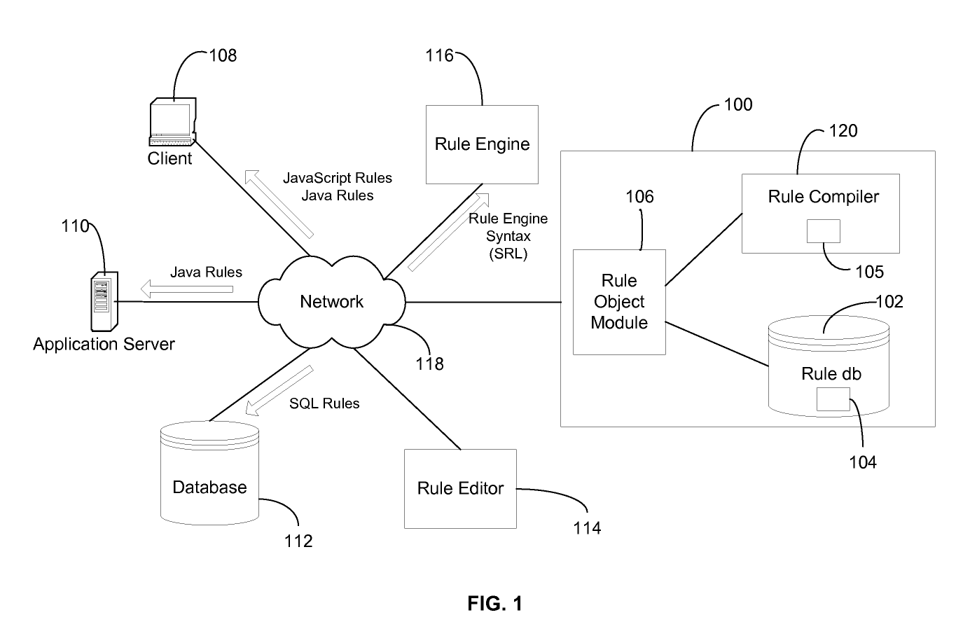

Turning to FIG. 1, an implementation of a system contemplated by an embodiment of the invention is shown with respect to an enterprise application environment including a business rules externalization system for centrally storing, compiling, and distributing computer readable business rules employed by a plurality of applications capable of executing the rules in their native application code. The rule externalization system 100 includes a rule database 102 for centrally storing a plurality of rules 104. The database 102 stores the rules 104 in a standardized format and includes multiple versions of a given rule or set of rules used by a plurality of applications, or by a single application in response to different triggering events. Preferably, the rule externalization system 100 employs a rule object module 106 to declare and store the rules 104 in a format conforming to a Rule Markup Language (RuleML) standard. In embodiments, the rule database 102 employs a relational database, XML files, or a flat file format to store the rules 104 on a computer readable medium, such as a hard drive, tape drive, or optical storage. The rules 104 comprise logical statements to provide inferential processing based on specified conditions, such as through forward chaining (data driven) or backward chaining (goal driven) evaluation. An exemplary rule 104 may include statements of the type “IF <condition> THEN <action>,” such as “IF Plan Type is HMO THEN display Primary Care Physician Information.”

The rule externalization system 100 customizes the rules 104 into native application code for delivery of customized rules 105 to a plurality of applications 108-116 via a network 118. In embodiments, the network 118 is a LAN network, a WAN network, or the Internet. The applications 108-116 include a client application 112, an application server-hosted application 110, a database application 112, a rule authoring application 114, and, optionally, a rules engine application 116. In an embodiment, the applications 108-116 are distributed among one or more enterprise and client systems hosted by a health care insurance provider. However, those skilled in the art will appreciate that the rule externalization system 100 is equally compatible with a variety of other contexts, such as, but not limited to, electronic commerce or life insurance systems, or any other context wherein applications 108-116 require an input of one or more business rules 105 for evaluation in native application code. In one embodiment, the rule externalization system 100 interfaces with one or more applications 108-116 by employing an application messaging infrastructure based on a service oriented architecture (SOA), such a by using a web services interface.

To load balance the processing of the rules 105, the rule externalization system 100 distributes the rules 105 among a plurality of application tiers to one or more applications 108-116 for local evaluation in native application code. For example, in one embodiment, the client application 108 is a thick client implementing a question and answer user interface (e.g., via a web browser running JavaScript code and/or Java applet) employed by a clinician during a disease management call with a patient for asking the patient a series of dynamically generated health questions to assess the patient's health status. Thus, the thick client 108 evaluates patient answers in accordance with one or more rules 105 coded in JavaScript or Java in order to dynamically generate subsequent questions (e.g., if patient is taking blood pressure medication, prompt for a most recent blood pressure reading). In another embodiment, a web-based thick client application 108 encounters a rule trigger requiring it to obtain rules 105 in native format to locally validate user input of form data or to provide user authentication.

Similarly, a middle tier application 110 evaluates one or more rules 105 in its native application code, for example in Java, to provide backend processing of data, such as message routing between applications, or any other type of rules-based processing capable of being performed on an application server. When the rules pertain to persistence, selection and manipulation of data, a database application 112 evaluates the rules 105 coded in Standard Query Language (SQL), such as to provide condition-based data storage or to facilitate condition-based data distribution and display. The rule editor application 114, in turn, creates and edits the rules 105. In one embodiment, the rule editor 114 is a Microsoft Excel™ application compatible with Binary Interchange File Format (BIFF) and Open Office XML file formats. Other embodiments include using a third-party dedicated rule editor application for creating and editing the business rules 105 in native syntax.

In an embodiment, at least some applications (e.g., a thin client) require an input of a rule evaluation result from a rules engine application 116. In this case, a dedicated rules engine application 116 processes the rules 105 in accordance with its native application code or format, such as Structured Rule Language (SRL). A suitable example of a rules engine application 116 includes Blaze Advisor™ available from Fair Isaac Corporation of 901 Marquette Avenue, Suite 3200, Minneapolis, Minn. 55402.

At predetermined points during application execution (trigger points), the application 108-116 requires an input comprising one or more native format rules 105 for local evaluation. Therefore, when the application 108-116 encounters a trigger point, it interfaces with a rule object module 106 to request the desired rules by passing a list of parameters comprising a name, id, and version number of the desired rule or rule set. The rule object module 106, in turn, queries the rule database 102 for the appropriate version of the requested rules and passes the standardized rules 104 to a compiler module 120 for customization. The rule compiler module 120 translates each rule or rule set 104 into application-specific computer executable code or format native to the calling application 108-116 and returns one or more native code-based rules 105 to the rule object module 106 for transmission to the calling application 108-116.

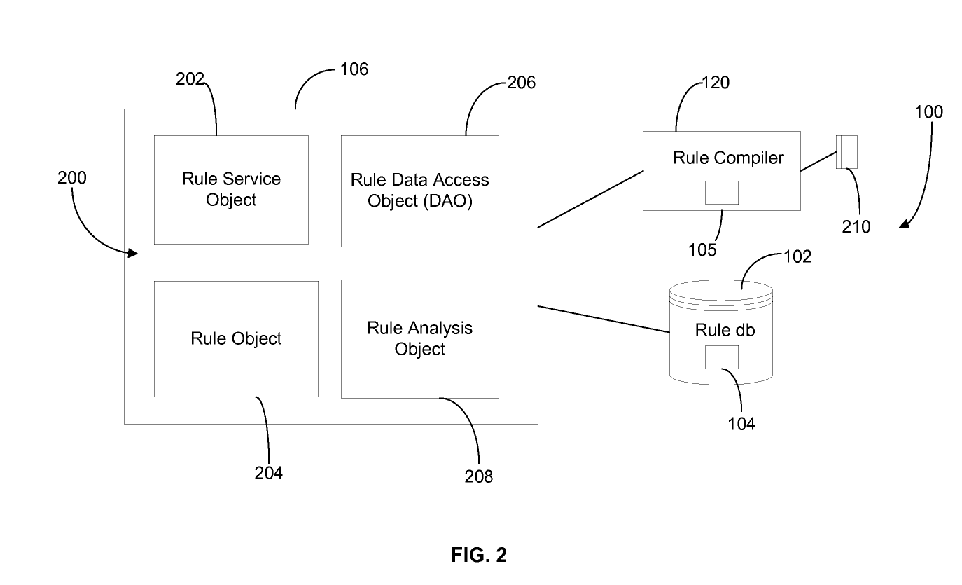

Turning to FIG. 2, an embodiment of the rule externalization system 100 is illustrated in more detail. The rule externalization system 100 comprises one or more computers or computer systems storing and executing instructions for implementing the rule object module 106, rule compiler 120, and rule database 102. Preferably, the rule object module 106 implements a rule object model 200 for declaring, maintaining, and communicating the rules. The rule object model 200 comprises a rule service object 202, a rule object 204, a rule data access object (rule DAO) 206, and a rule analysis object 208. The rule service object 202 receives a set of parameters comprising a rule request (e.g., a rule or rule set name, id, version number) from one or more calling applications 108-116 and queries the rule database 102 for the standardized version of one or more rules 104. The rules 104 are instantiated via a rule object 204. The rule compiler 120, receives one or more rule objects 204 and compiles the standardized rules 104 into computer executable code native to the calling application 108-116. In one embodiment, the rule compiler 120 accesses a registry or a lookup table 210 for matching incoming rule requests with native application code specific to a given calling application 108-116. Alternatively, the rule compiler 120 identifies native application code based on rule request parameters passed by the application 108-116. Upon generating native application code to customize the rule 104, the rule compiler 120 passes the customized rule 105 to the calling/requesting application 108-116.

When rules are added or edited via the rule editor application 114, the rule data access object 206 generates rule update events for notifying the applications 108-116 of rule changes. Similarly, to provide an interface for rule testing and analysis, the rule analysis object 208 includes an interface for seeding rule test data, analyzing results of test rule evaluations, and reporting an impact of rule changes on applications that share the rules.

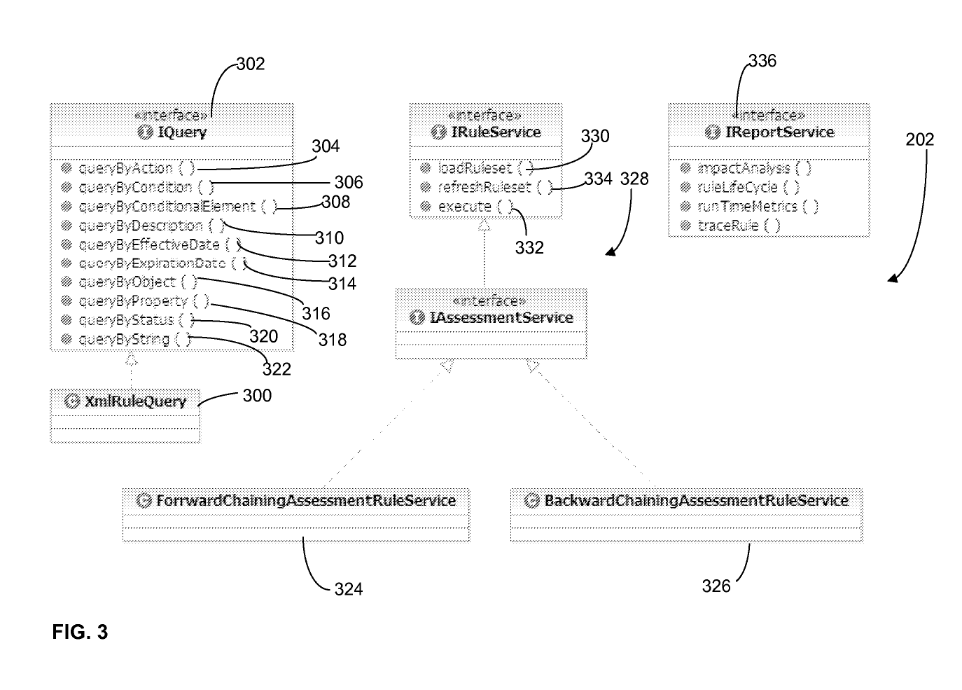

FIGS. 3-6 illustrate embodiments of class diagrams representing the rule service object 202, rule object 204, rule data access object 206, and rule analysis object 208 of an extensible rule object model 200. In FIG. 3, the rule service object 202 includes a plurality of classes implementing interfaces for querying the rule database 102 for rules by a plurality of conditions, loading and executing the native code rules 105, and analyzing runtime rule evaluation results. For instance, a rule editor application 114 queries the rule database 102 for rules 104, 105 based on various conditions. In an embodiment, the XmlRuleQuery class 300 implements the IQuery interface 302 via a plurality of methods 304-322 to query the rule database 102. In an embodiment, the IQuery interface 302 includes the following methods:

queryByAction method 304 queries the rule database 102 by a specified action (e.g., a rule that results in displaying primary care physician information);

queryByCondition and queryByConditionalElement methods 306, 308 query the rule database 102 for rules 104 that include specified test conditions, for example rules that evaluate whether a member of a health network belongs to an HMO plan;

queryByDescription method 310 searches the rule database 102 by a rule description field;

queryByEffectiveDate and queryByExpirationDate methods 312, 314 search for rules having specified effective and/or expiration dates to locate temporary and time-varying rules;

queryByObject method 316, queryByProperty method 318, queryByStatus method 320, and queryByString method 322 search the rule database 102 by rule object type, property, rule status (e.g., active or inactive), and specified string (e.g., a zip code string), respectively.

Additionally, the ForwardChainingAssessmentRuleService class 324 and BackwardChainingAssessmentRuleService class 326 implement the IAssessmentService interface hierarchy 328 for loading and executing the native application code rules 105 during runtime. The rules 105 are executed via forward or backward chaining inference routines. At startup or at a predetermined trigger point, an application 108-116 requests the native format rules 105 by invoking a loadRuleset method 330. In one embodiment, the loadRuleset method 330 obtains a requested rule or rule set 104 from the rule database 102 and forwards it to the rule compiler 120 for generating a rule or rule set 105 in the application's native code or format. The execute method 332, in turn, sends the requested rule or rule set 105 from the rule compiler 120 to the calling application 108-116 for evaluation. A refreshRuleset method 334 is invoked in a testing or development environment to refresh the current view of a specified rule set pursuant to rule edits and updates. In one embodiment, the rule service object 202 communicates the native application code rules 105 to the calling application 108-116 via a web services interface. Finally, the IReportService interface 336 includes methods for analyzing runtime rule evaluation errors and results.

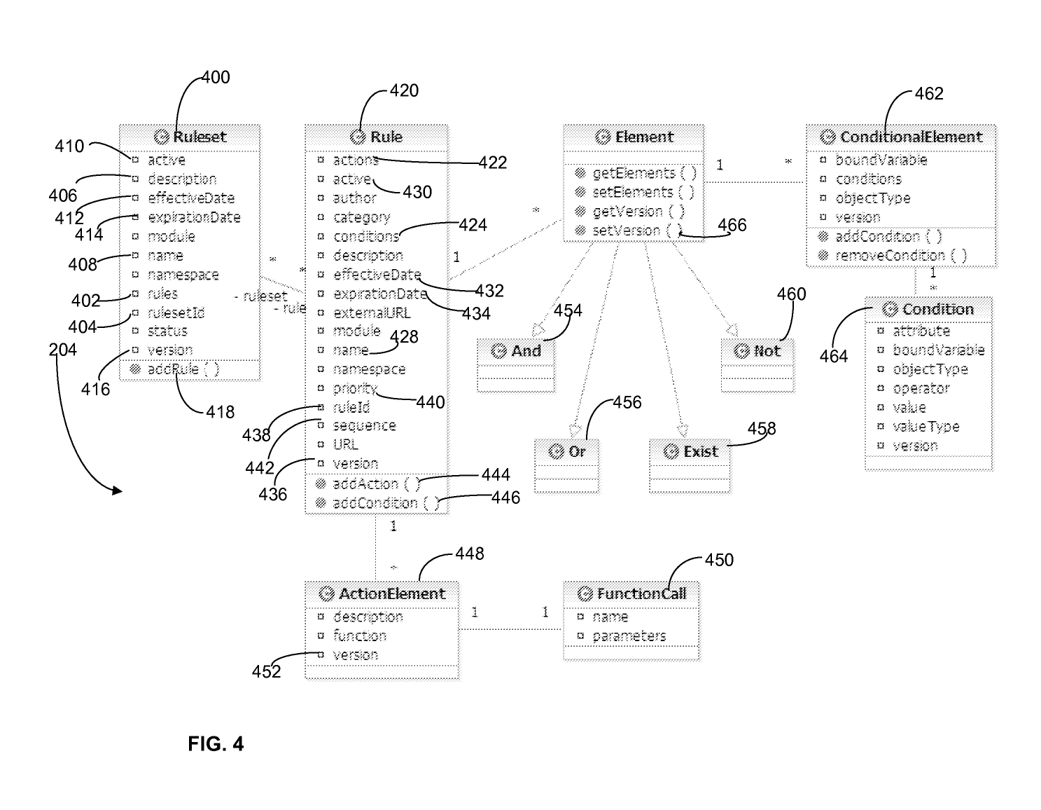

Turning to FIG. 4, an embodiment of a class diagram of a rule object 204 for declaring one or more standardized rules 104 is illustrated. The Ruleset class 400 organizes a plurality of related rules 402 into a rule set identified by a rulesetId field 404, description field 406, and name field 408. The rules field 402 includes a list of rules forming the rule set, such as by rule name and/or rule id number. The active field 410 comprises a “Y” or “N” status indicator for activating the rule set. Similarly, effectiveDate and expirationDate fields 412, 414 specify the effective and expiration dates of a particular rule set, respectively. Preferably, the version field 416 specifies a particular version of a rule set to provide the calling applications 108-116 with customized execution versions of the rules based on the use case. For example, a version of a rule set called by a thick client application 108 may include additional rules directed to formatting the display based on the browser's capabilities, while a middle tier version of the same rule set may not require display formatting functionality. In another embodiment, a disease management client 108 runs multiple versions of the same rule or rule set. In yet another embodiment, the version field 416 corresponds to the most recent version of a rule set after editing the rules and/or adding additional rules to the rule set. Additional rules are added to the rule set via an addRule method 418.

Each Ruleset class 400 corresponds to a plurality of rules 104 declared via the Rule class 420. The Rule class 420 specifies the rule logic behind each rule 104 by way of the actions field 422 and conditions field 424. Similar to the Ruleset class 400, the Rule class 420 includes a description field 426, a name field 428, an active status indicator 430, effective and expiration date fields 432, 434, and a rule version field 436. In embodiments, the version field 436 provides for multiple versions of a given rule specific to each application 108-116 or indicates the most recent version of the rule. The ruleId field 438 corresponds to a specific rule id number. Additionally, the Rule class 420 comprises a priority field 440 for specifying rule execution priority at the calling application (e.g., high or low priority). The sequence field 442, on the other hand, defines a specific sequence number for execution of the rule as an alternative to the priority field 440.

New actions and conditions are added to each Rule class 420 via the addAction method 444 and addCondition method 446, respectively. The actions field 422 calls a plurality of functions implemented via the ActionElement class 448 and FunctionCall class 450, including version control of rule actions via the version field 452. Conditional logic 424 includes a plurality of logical elements 454-460 (e.g., “and,” “or,” “exist,” “not”) operating on conditional elements 462, 464, including version control of condition updates via the setVersion method 466.

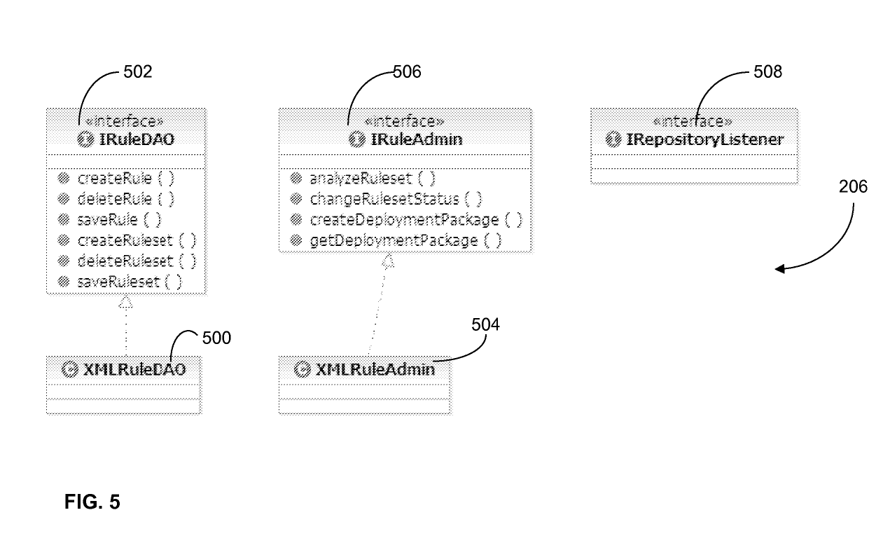

Turning to FIG. 5, an embodiment of a class diagram of a rule data access object 206 is illustrated. Specifically, the XMLRuleDAO class 500 implements an IRuleDAO interface 502 comprising a plurality of methods to create, delete, and save rules and rule sets. The XMLRuleAdmin class 504 implements an IRuleAdmin interface 506 for managing and analyzing the standardized rule sets 104 and creating deployment packages for production. The IRepositoryListener interface 508 monitors the status of the rules 104 at the database 102 and generates rule update events for notifying the applications 108-116 of rule changes. In an embodiment, a developer may choose to update his or her view of the current rule base in a rule editor application when a rule update event identifies changes to relevant rule sets.

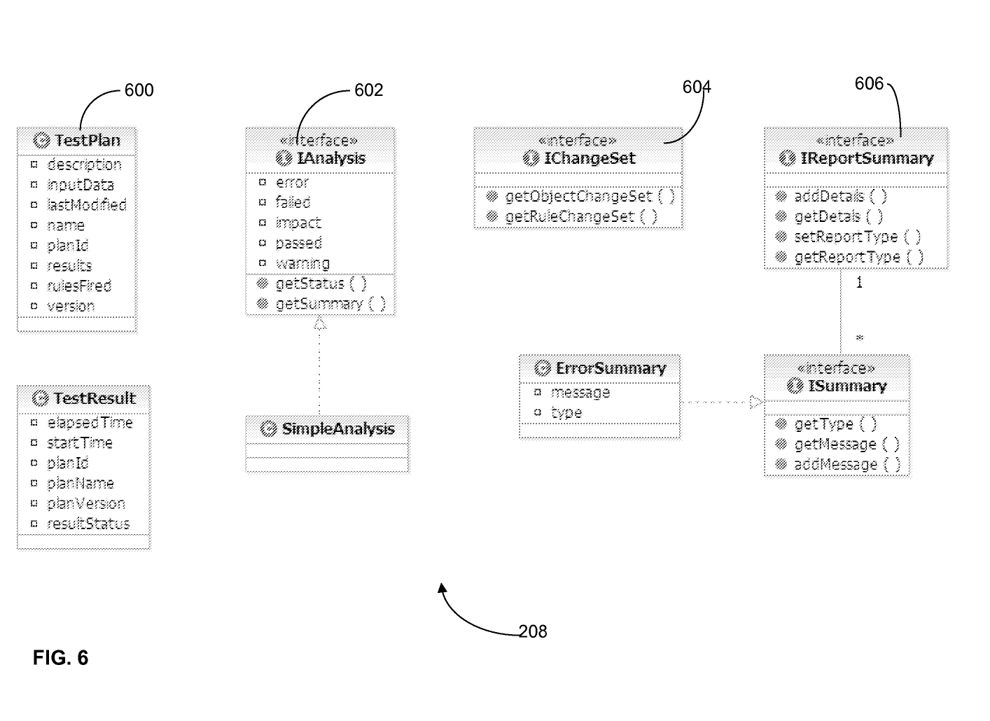

Turning to FIG. 6, an embodiment of a class diagram of a rule analysis object 208 is illustrated. The TestPlan class 600 is used in a rule testing and development environment to specify a test plan scenario, provide rule test data, and specify expected rule test results. Upon test plan completion, the IAnalysis interface 602 provides feedback of actual test results, including an error summary and a listing of passed and failed rules 104. Preferably, the rule test results are stored in the rule database 102 for subsequent query, analysis, and validation. Similarly, the IChangeSet interface 604 provides feedback of rules affected by format changes. Finally, the IReportSummary interface 606 controls details of the rule test reports.

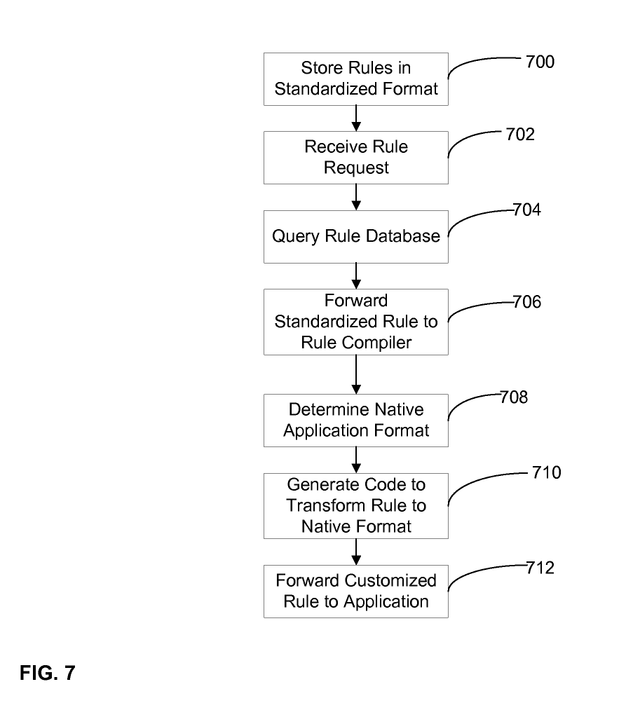

Turning to FIG. 7, a method for externalizing a plurality of computer readable business rules is illustrated. In step 700, a plurality of business rules 104 is stored in a rule database 102 in a standardized format, such as in a format conforming to a RuleML standard. A rule object module 106 implements a rule object model 200 for declaring, maintaining, and communicating the rules. When the rule object module 106 receives a rule request from an application 108-116, step 702, it queries the rule database 102 for the requested rule or rule set, step 704. Upon locating requested rules, the rule object module 106 forwards the standardized rules to the rule compiler 120, step 706. The rule compiler 120, in turn, determines the native format or application code of the requesting application 108-116, step 708. In one embodiment, the rule compiler 120 references a registry or lookup table 210 to match the requesting application with its native format. Alternatively, the application 108-116 passes its native application format as a parameter during a rule request. In step 710, the rule compiler generates code to transform the standardized rule 104 into a customized rule 105 declared in the application's 108-116 native format or code. Finally, in step 712, the rule object module 106 forwards the customized rule or rule set 105 to the requesting application 108-116 for local execution.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer system for externalizing a plurality of computer readable business rules, the system comprising:
a rule repository for centrally storing the plurality of computer readable business rules in a standardized format;
a rule object module for querying the rule repository for at least one business rule in response to receiving a rule request from an application; and
a rule compiler module for receiving the at least one business rule from the rule object module and compiling the at least one business rule from the standardized format to a computer readable native application format, the rule object module forwarding at least one compiled business rule from the rule compiler module to the application for evaluating the at least one compiled business rule in the computer readable native application format to perform an action.

2. The system of claim 1 wherein the application is a question and answer health assessment application.

3. The system of claim 1 wherein the application is a health care insurance provider application.

4. The system of claim 1 wherein the application is selected from the group consisting of a client application, a web browser application, a server application, and a database application.

5. The system of claim 1 wherein the rule object module implements a rule object model for declaring, maintaining, and communicating the plurality of computer readable business rules.

6. The system of claim 5 wherein the rule object model comprises at least one of a rule object, a rule service object, a rule analysis object, and a rule data access object.

7. The system of claim 6 wherein the rule object comprises a version field for storing multiple versions of the at least one business rule.

8. The system of claim 1 wherein the standardized format conforms to a RuleML standard.

9. The system of claim 1 wherein the application executes the at least on compiled business rule based on one of a forward chaining routine and a backward chaining routine.

10. The system of claim 1 wherein the action is selected from the group consisting of validating input data, authenticating a user, and generating follow up questions in response to user answers.

11. The system of claim 1 wherein the computer readable native application format comprises at least one of Java code, JavaScript code, SQL code, rule engine application readable format, and a rule editor application readable format.

12. A computer readable medium having stored thereon computer executable instructions for externalizing a plurality of computer readable business rules, the instructions comprising:
centrally storing the plurality of computer readable business rules in a standardized format;
initiating a query for at least one business rule in response to receiving a rule request from an application;
locating the at least one business rule and compiling the at least one business rule from the standardized format to a computer readable native application format; and
forwarding at least one compiled business rule to the application for evaluating the at least one compiled business rule in the computer readable native application format to perform an action.

13. The computer readable medium of claim 12 wherein the application is a health care insurance provider application.

14. The computer readable medium of claim 12 wherein the application is selected from the group consisting of a client application, a web browser application, a server application, and a database application.

15. The computer readable medium of claim 12 wherein the instructions further comprise implementing a rule object model for declaring, maintaining, and communicating the plurality of computer readable business rules.

16. The computer readable medium of claim 12 wherein the instructions further comprise storing multiple versions of the at least one business rule.

17. The computer readable medium of claim 12 wherein the instructions further comprise executing the at least on compiled business rule based on one of a forward chaining routine and a backward chaining routine.

18. The computer readable medium of claim 12 wherein the action is selected from the group consisting of validating input data, authenticating a user, and generating follow up questions in response to user answers.

19. The computer readable medium of claim 12 wherein the computer readable native application format comprises at least one of Java code, JavaScript code, SQL code, rule engine application readable format, and a rule editor application readable format.

20. In a computer system, a method for externalizing a plurality of computer readable business rules, the method comprising:
centrally storing the plurality of computer readable business rules in a standardized format;
initiating a query for at least one business rule in response to receiving a rule request from an application;
locating the at least one business rule and compiling the at least one business rule from the standardized format to a computer readable native application format; and
forwarding at least one compiled business rule to the application for evaluating the at least one compiled business rule in the computer readable native application format to perform an action.

21. The method of claim 20 wherein the application is a health care insurance provider application.

22. The method of claim 20 further comprising implementing a rule object model for declaring, maintaining, and communicating the plurality of computer readable business rules.

23. The method of claim 20 wherein the computer readable native application format comprises at least one of Java code, JavaScript code, SQL code, rule engine application readable format, and a rule editor application readable format.
